(19) United States
(12) Patent Application Publication
(10) Pub. No.: US 2025/0143217 A1
(43) Pub. Date: May 8, 2025

(54) VARIABLE HARDENING OF CORN PROCESSING ROLLS

(71) Applicant: Horning Manufacturing, LLC, New Holland, PA (US)

(72) Inventors: David H. Horning, East Earl, PA (US); Leon H. Horning, JR., Ephrata, PA (US)

(73) Assignee: Horning Manufacturing, LLC, New Holland, PA (US)

(21) Appl. No.: 18/932,314

(22) Filed: Oct. 30, 2024

Related U.S. Application Data
(60) Provisional application No. 63/547,232, filed on Nov. 3, 2023.

(51) Int. Cl. A01D 82/02; A01D 43/10

(52) U.S. Cl. CPC A01D 82/02; A01D 43/102

(57) ABSTRACT

A crop processing roll has the outer cylindrical surface thereof hardened differently at selected areas along the axial length of the crop processing roll. Typically, the high wear areas on at least one end of the crop processing roll have higher levels of hardening, while the low wear area at the central portion of the roll has a lesser level of hardening. The preferable system for hardening is a High Velocity Air Fuel system in which a powdered carbide and metal is mixed in a combustion chamber with air and fuel before applied through an injection gun at different flow rates to selected areas on the crop processing roll. Alternatively, the crop processing roll can be segmented with various segments having different levels of surface hardening, which can be done by conventional heat treating, electroplating or HVAF application of material, and assembled as appropriate to position hardened areas where needed.

### CROSS-REFERENCE TO RELATED APPLICATIONS

This application claims domestic priority on U.S. Provisional Patent Application Ser. No. 63/547,232, filed on Nov. 3, 2024, the content of which is incorporated herein by reference.

### FIELD OF THE INVENTION

This invention relates generally to forage harvesters, and more specifically to a process for hardening crop processing rolls used in the corn kernel cracking section of a forage harvester.

### BACKGROUND OF THE INVENTION

Forage harvesters are mobile machines designed to chop whole corn plants into small pieces to be fed to cattle and other livestock. Conventional forage harvesters are manufactured with a cutterhead formed with spiraled knives and rotate about a horizontal axis to chop forage material, such as corn or alfalfa, into small pieces that are typically fermented through a process referred to as ensilage. The forage harvester first severs the plants from the ground and conveys the severed plants into the path of the rotating cutterhead. By manipulating the speed at which the crop material is conveyed and the speed at which the cutterhead is rotated, the length of the small pieces of crop material can be varied as desired by the operator.

Forage harvesters can also utilize a pair of counter rotating crop processing rolls which rotate about parallel axes and define a gap therebetween. The crop material can pass through this gap after being chopped into small pieces by the rotating cutterhead to crack the kernels of corn that may be in the flow of crop material exiting the cutterhead. By cracking the corn kernels, livestock, particularly dairy cattle, have improved digestibility, and produced more and higher quality milk. The crop material discharged from between the corn processing rolls is fed into a blower that moves the chopped crop material through a discharge chute to be deposited into a container, such as a forage wagon that is typically connected to the forage harvester and trails behind the harvester to receive the chopped crop material. Once filled, the forage wagon is disconnected and taken to a storage facility where the forage wagon is emptied and returned to the forage harvester for refilling.

Conventional crop processing rolls, also referred to as corn processing rolls, are constructed with longitudinally extending grooves machined into the rolls, which can then be reduced to individual teeth by continuous spiral grooves that are machined around the circumference of the roll to form peaks and valleys along the longitudinal, axial length of the outer circumferential surface of the corn processing rolls. In cross-section, these peaks and valleys can resemble saw teeth.

Due to the high cost of forage harvesters and limited harvesting time when the crop is ready to be harvested, harvesting speed is very critical to the successful operation of a forage harvester. One of the known limitations on the harvesting speed in forage harvester configurations that utilize corn processing rolls is the operating speed of the corn processing rolls. With increasing harvesting speeds being demanded of the operation of forage harvesters, the corn processing rolls require advanced design to prevent the corn processing rolls from being a bottleneck in the operation of a forage harvester.

Known prior art machines have attempted to overcome this limitation by running the corn processing rolls at higher speeds, but have had limited success because of centrifugal force limits on the rolls and speed limitations on the bearings rotatably supporting the corn processing rolls. Another known prior art approach to increasing operating speeds approach has been to space the peaks on the roll surfaces farther apart, but this technique results in some kernels passing between the corn processing rolls without being cracked.

A representative example of the design of corn processing rolls for use in a forage harvester is disclosed in U.S. Pat. No. 8,480,019, granted on Jul. 9, 2013, to Bob A. Scherer, et al, in which the corn processing roll is formed with a series of longitudinally spaced grooves that define elongated axially aligned ridges between the longitudinal grooves. The corn processing roll then goes through a subsequent manufacturing process to form a spiraled groove extending circumferentially around the corn processing roll, as is best seen in FIG. 4. The longitudinal and spiral grooves disclosed in the '019 patent are formed with a v-shaped bit that creates corresponding V-shaped grooves, resulting in discrete teeth around the circumference of the corn processing roll that have a larger base than the top portion of the respective tooth, as is best seen in FIG. 5 of the '019 patent.

Crop processing rolls have been manufactured by Horning Manufacturing, LLC, for many years in a variety of configurations, including corn processing rolls with longitudinal and spiral grooves similar to that of the '019 patent, but formed with a rounded bit that creates vertical sides of the respective teeth around the circumference of the corn processing rolls. Certain configurations of the Horning Manufacturing, LLC, crop processing rolls have also been operated at differential speeds of rotation to provide a more aggressive shredding of the crop material being chopped by the forage harvester.

These corn processing rolls, such as is represented in the '019 patent, formed with a spiral groove around the circumference, irrespective of the shape of the grooves, tend to urge the movement of the crop material passing between the crop processing rolls toward the end of the corn processing rolls that faces the leading slope of the spiral groove. In other words, the spiral flighting of the circumferential groove pushes crop material toward the leading end of the rolls. While the leading slope of the circumferential spiral is not very aggressive, there has been sufficient movement of the crop material toward the leading end to cause more failures for the bearings supporting the rotation of the corn processing rolls at the leading end than occur at the trailing end.

Alternative designs for crop harvesting roll configurations have included a chevron pattern in which the spiral grooves are oriented with opposite leading slopes from opposing ends of the crop processing roll. As is taught in U.S. Pat. No. 9,918,432, granted to Leon H. Horning, Jr., et al, on Mar. 20, 2018, this chevron pattern can meet at a V-shaped configuration at the center of the crop processing roll, or terminate in a spaced relationship with respect to the opposing grooves near the center of the crop processing roll. These opposingly sloped grooves are oriented to direct crop flow, while the crop is in contact between the set of crop processing rolls, toward the center of the crop processing rolls. Nevertheless, even the chevron grooved crop processing rolls exhibit a greater wear from operative usage of the processing rolls near the ends of the respective crop processing rolls.

It would be desirable to provide a configuration of corn processing rolls for use in forage harvesters that would facilitate the high speed harvesting operation of forage harvesters without sacrificing quality of operation. It would also be desirable to provide a configuration for corn processing rolls that would not overly wear the corn processing rolls near one or both of the respective ends of the corn processing rolls.

### SUMMARY OF THE INVENTION

It is an object of this invention to overcome the disadvantage of the prior art by providing a variable hardening of predefined areas of the crop processing rolls used in forage harvester operations.

It is another object of this invention to provide crop processing rolls for use in forage harvesters that will be operative longer that conventional crop processing rolls.

It is an advantage of this invention that the cost of manufacture of hardening crop processing rolls is reduced.

It is a feature of this invention that the hardening of the outer surface of a crop processing roll is varied over preselected areas of the crop processing roll.

It is another feature of this invention that at least one end of the crop processing roll has more hardening material applied than the central portion of the crop processing roll.

It is another advantage of this invention that a crop processing roll formed with a chevron pattern of grooves and teeth has more hardening material applied to both opposing ends of the crop processing roll than the central portion thereof.

It is still another object of this invention that the hardening material is applied to the outer circumferential surface of the crop harvesting roll by streaming hardening material through a High Velocity Air Fuel (HVAF) system.

It is still another feature of this invention that the hardening material is applied from an injection gun to the outer circumferential surface of the crop processing roll.

It is still another advantage of this invention that the thickness of the hardening material applied by the injection gun is a function of the flow rate from the HVAF system into the injection gun.

It is yet another feature of this invention that the hardening material is a powdered cemented carbide and metal that is fed into the combustion chamber with the fuel utilized in the HVAF system.

It is a further feature of this invention that an alternative to the HVAF system would be electroplating chrome onto the outer surface of the crop processing rolls.

It is yet another object of this invention that a segmented configuration of a crop harvesting roll can be hardened through conventional heat treating processes, electroplating chrome or an HVAF process to provide variable hardening of the outer surface of the crop processing roll.

It is yet another advantage of this invention that differently hardened surfaces of crop processing roll segments can be assembled in a manner that the more hardened surface segments would correspond to the high wear areas of the crop processing roll while the less hardened surface segments would correspond to the central portions of the crop processing rolls where the lower wear areas are found.

It is a further object of this invention to provide a variably hardened outer surface on a crop processing roll that is that is durable in construction, carefree of maintenance, easy to assemble, and simple and effective in use.

These and other objects, features and advantages are accomplished according to the instant invention by providing a crop processing roll in which the outer cylindrical surface thereof is hardened differently at selected areas along the axial length of the crop processing roll. Typically, the high wear areas on at least one end of the crop processing roll have higher levels of hardening, while the low wear area at the central portion of the roll has a lesser level of hardening. The preferable system for hardening is a High Velocity Air Fuel system in which a powdered carbide and metal is mixed in a combustion chamber with air and fuel before applied through an injection gun at different flow rates to selected areas on the roll. The crop processing roll can be segmented with various segments having different levels of surface hardening, which can be done by conventional heat treating, electroplating or HVAF application of material, and assembled as appropriate to position hardened areas where needed.

### BRIEF DESCRIPTION OF THE DRAWINGS

The foregoing and other objects, features, and advantages of the invention will appear more fully hereinafter from a consideration of the detailed description that follows, in conjunction with the accompanying sheets of drawings. It is to be expressly understood, however, that the drawings are for illustrative purposes and are not to be construed as defining the limits of the invention.

FIG. 1 is a schematic partial cross-sectional view of a conventional forage harvester having a corn processing unit installed between the cutterhead and the blower;

FIG. 2A is an elevational view of a first embodiment of a corn processing roll incorporating the principles of the instant invention;

FIG. 2B is an elevational view of a second embodiment of a corn processing roll incorporating the principles of the instant invention;

FIG. 2C is an elevational view of a third embodiment of a corn processing roll incorporating the principles of the instant invention;

FIG. 3 is an enlarged perspective view of a central portion of the processing roll incorporating the configuration of the second embodiment of the instant invention as shown in FIG. 2B;

FIG. 3A is an enlarged perspective view of a central portion of the processing roll incorporating the configuration of the third embodiment of the instant invention as shown in FIG. 2C;

FIG. 4 is an elevational view of a fourth embodiment of a crop processing roll shell having only horizontally oriented grooves milled into outer circumferential surface of the roll shell;

FIG. 5 is a perspective view of a fifth embodiment of a crop processing roll that is formed by a series of individual roll segments mounted on a central shaft, with each pair of adjacent roll segments having opposingly sloped spiral grooves formed therein;

FIG. 6 is a partial schematic cross-sectional view of the fifth embodiment shown in FIG. 5 to depict the mounting of the individual roll segments on the central drive shaft; and

FIG. 7 is a schematic cross-sectional view of a representative injection gun for applying a hardening material to a target device using a high velocity air fuel (HVAF) system.

### DETAILED DESCRIPTION OF THE PREFERRED EMBODIMENT

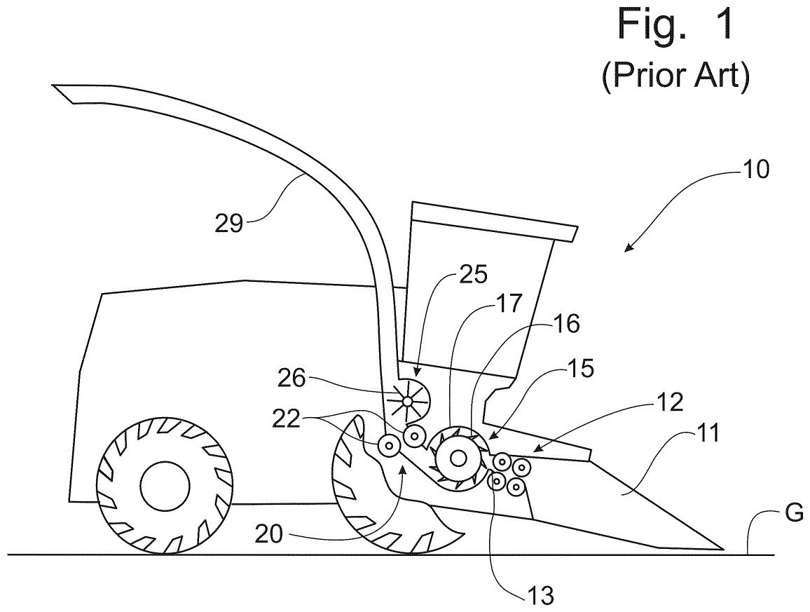

Referring to the drawings, corn processing rolls incorporating the principles of the instant invention can best be seen. A conventional forage harvester 10, as depicted schematically in FIG. 1, includes a header 11 at the forward end thereof to collect crop material from the surface of the ground G, typically by severing the crop adjacent to the ground G and conveying the severed crop material rearwardly for further harvesting. The severed crop material is typically delivered to a feed roll mechanism 12 that orients the crop material as a flat mat that is advanced toward a rotating cutterhead 15 having knives 16 mounted thereon to sever the crop material into small pieces as the mat of crop material passes over a shear bar 13. The rapidly rotating cutterhead 15 rotating within a housing 17 propels the severed crop material pieces to the corn processing roll assembly 20 having a pair of corn processing rolls 22 separated by a gap through which the propelled comminuted crop material pieces pass.

One of the corn processing rolls 22 is normally biased toward the opposing corn processing roll 22 by springs (not shown) that keep the spacing minimized to provide the operation of cracking the kernels of corn within the pieces of crop material passing through the corn processing roll assembly 20. Furthermore, the respective rolls 22 are normally driven at differential speeds to shred the crop material passing between the two rolls 22. The rotating corn processing roll assembly 20 in turn propels the processed pieces of crop material upwardly into a blower 25 having vanes 26 that project the chopped and processed crop material through a discharge chute 29 into a trailing forage wagon (not shown) that collects the discharged crop material for transport to a storage facility (not shown).

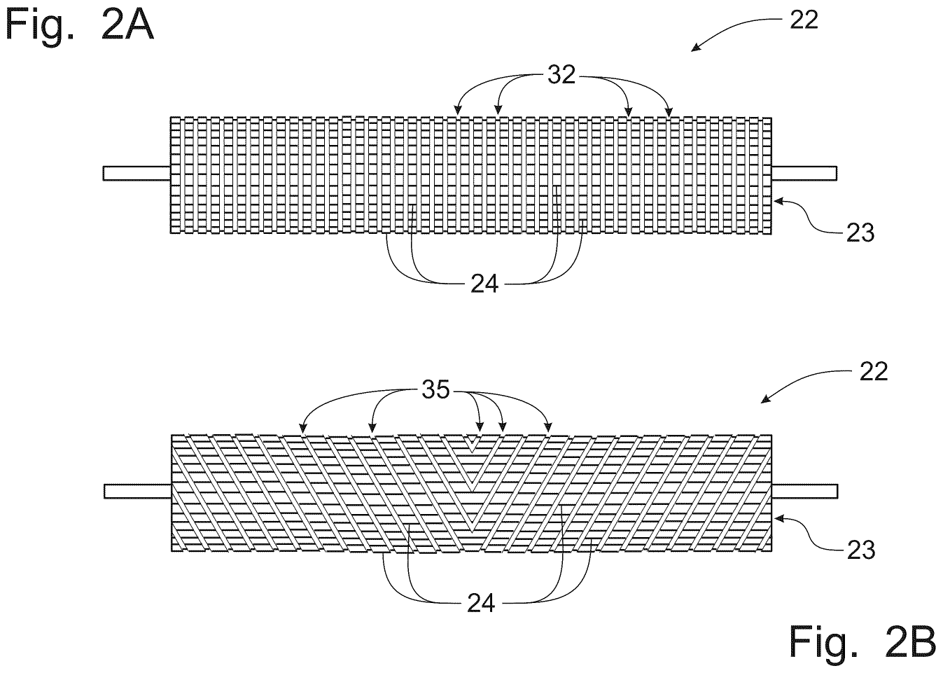

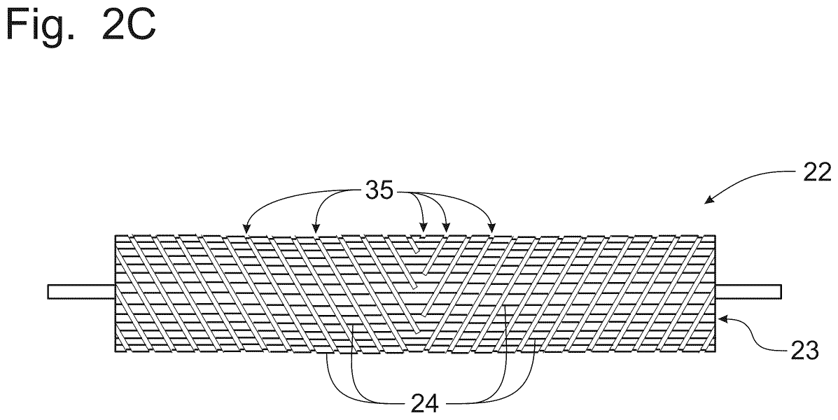

The present invention increases the quantity of chopped corn plants, particularly with respect to the corn kernels found in the supply of chopped corn plants, that the corn processing rolls provide without requiring the speed of rotation of the corn processing rolls be increased. This increase in productivity is accomplished by placing multiple notches along the length of the longitudinally oriented peaks formed along the axial length of the outer surface of the corn processing rolls 22. Furthermore, by use of the instant invention, the preferred spacing between the longitudinal peaks can be maintained and multiple longitudinal teeth are created by the placement of the circumferential grooves around the corn processing rolls to intersect the longitudinal peaks, as is best seen in FIGS. 2A and 2B. Since the overall diameter of the corn processing rolls are not increased, and since the corn processing rolls can be operated at the conventional speed of the previous corn processing rolls, the rolls 22 formed according to the instant invention can be retrofitted into existing machines to increase the capacity thereof by merely replacing the previous corn processing rolls with rolls manufactured according to the principles of the instant invention.

Five configurations of corn processing rolls 22 according to the principles of the instant invention are depicted in FIGS. 2A-2C, 4 and 5. The intent of these corn processing rolls 22 is to provide increased capacity rolls 22 without utilizing a spiral circumferential groove that will shift crop material laterally as the crop material is passed between the rotating corn processing rolls 22. The first embodiment of the processing roll 22 shown in FIG. 2A is formed with the longitudinally extending grooves 23 running parallel with the axis of rotation of the processing roll 22, but a series of parallel spaced-apart circumferential grooves 32 divide the ridges 24 formed by the longitudinal grooves 23 into discrete teeth. With the use of the parallel grooves 32 forming spaced-apart rings around the outer circumference of the processing roll 22, the circumferential grooves 32 do not urge the movement of crop material passing between the processing rolls 22 to move toward one of the bearings and cause an overloading thereof.

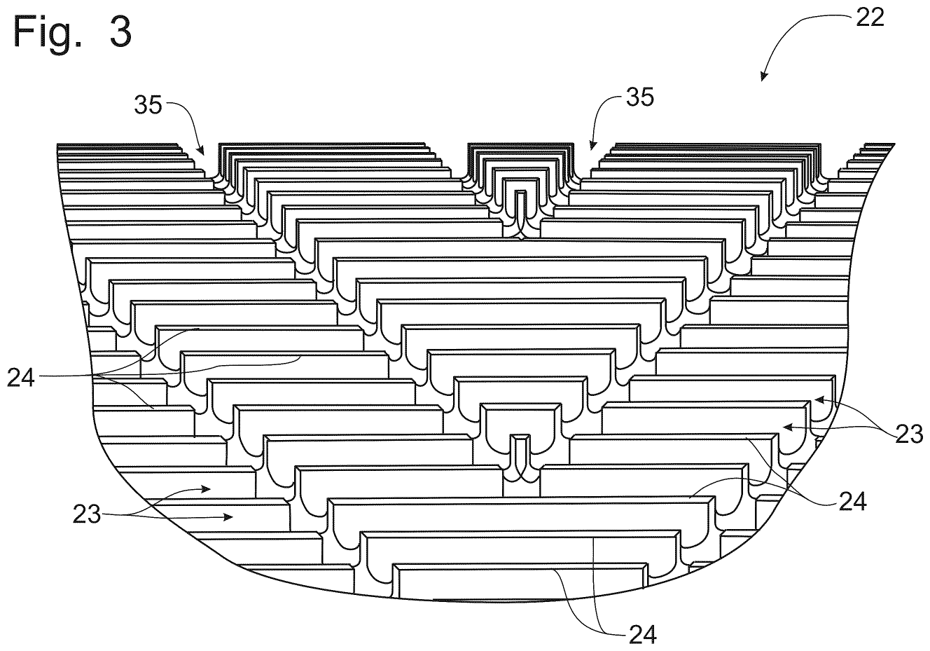

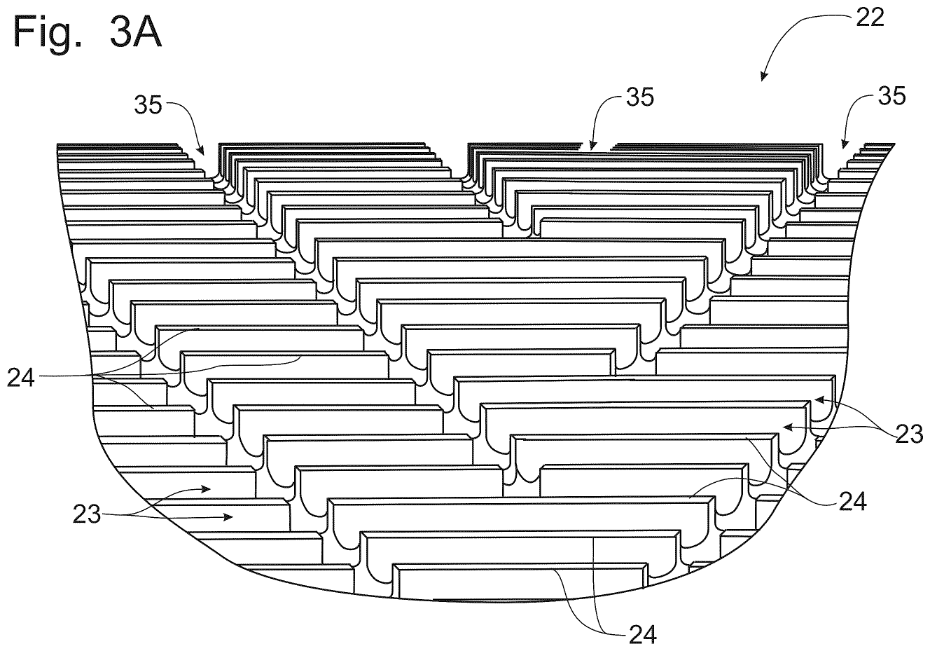

The processing roll 22 incorporating the configuration of the second embodiment depicted in FIG. 2B and in the enlarged portion of the corresponding processing roll 22 shown in FIG. 3, is also formed with the longitudinally extending grooves 23 running parallel with the axis of rotation of the processing roll 22, but is intersected with a spiraled circumferential groove 35 formed in the shape of a chevron. In this second embodiment configuration, the circumferential groove 35 spirals in opposing directions from the opposing ends of the processing roll 22, meeting at the center in a V-shape, thus form the chevron configuration. As opposed to a continuous spiral circumferential groove extending from one end of the processing roll 22 to the other, as is known in the prior art, which causes the crop material being processed between the processing rolls to move toward one end of the processing roll 22, the chevron design will urge movement of the crop material being processed away from the opposing ends of the processing roll 22 and toward the center of the roll 22. Accordingly, with the chevron groove 35 configuration, as with the parallel circumferential groove 32 configuration, the bearings at one end of the processing roll 22 is not consistently overloaded.

The configuration of the third embodiment of the instant invention as shown in FIG. 2C and in the enlarged portion of the corresponding processing roll shown in FIG. 3A, is similar to the second embodiment noted above, but leaves a gap between the oppositely slanted circumferential grooves 35. This semi-chevron configuration of circumferential grooves 35 does not create and leave a short tooth formed from the ridge 24 at the intersection of the oppositely oriented circumferential grooves 35. In other words, the “V” of the chevron grooves 35 in the second embodiment depicted in FIG. 2B will leave a short portion of the ridge 24 at the point of the “V”. By stopping the circumferential grooves 35 prior to actually intersecting the oppositely winding circumferential groove 35, only longer teeth are created from the ridges 24, as compared to the length of the ridge segments 24 between parallel circumferential grooves 35, rather than forming shorter ridge segments (teeth).

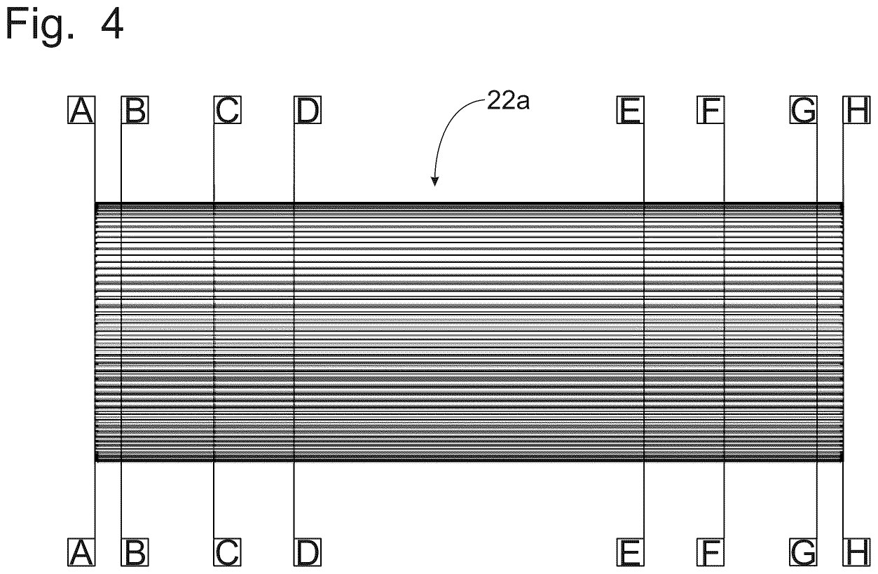

The fourth embodiment of crop processing rolls incorporating the instant invention is shown in FIG. 4, which depicts only the shell 22a of the crop processing roll 22 before having ends welded into the shell 22a and a drive shaft 52 mounted thereto. FIG. 4 also teaches the principles of the instant invention with respect to a variable hardening of the various circumferential areas of the crop processing rolls, which are discussed in greater detail below. One of ordinary skill in the art will recognize that the principles of the instant invention apply to all configurations of crop harvesting rolls 22, including a fifth embodiment described below.

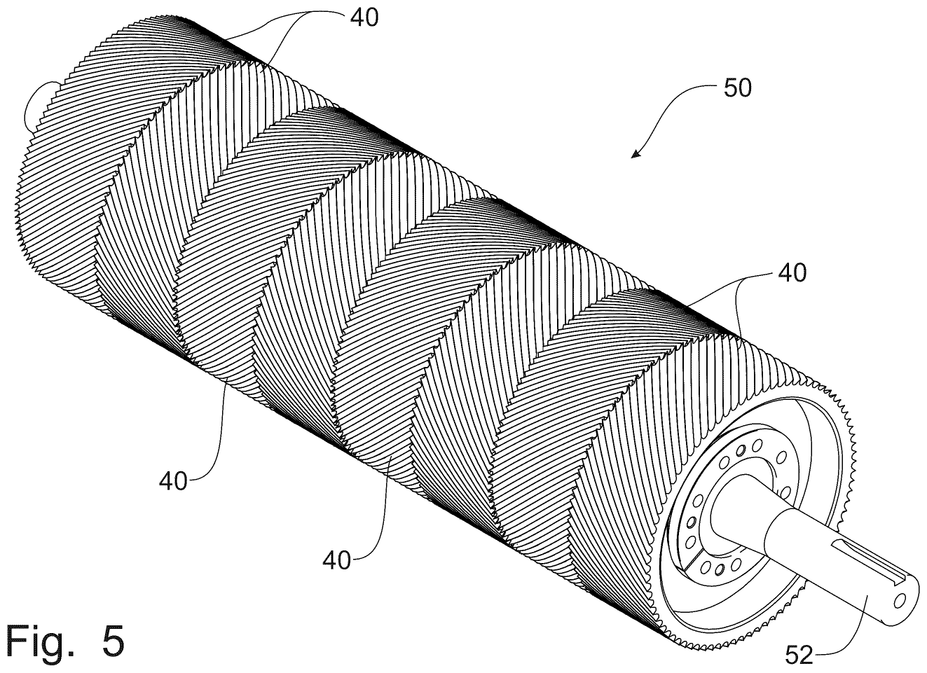

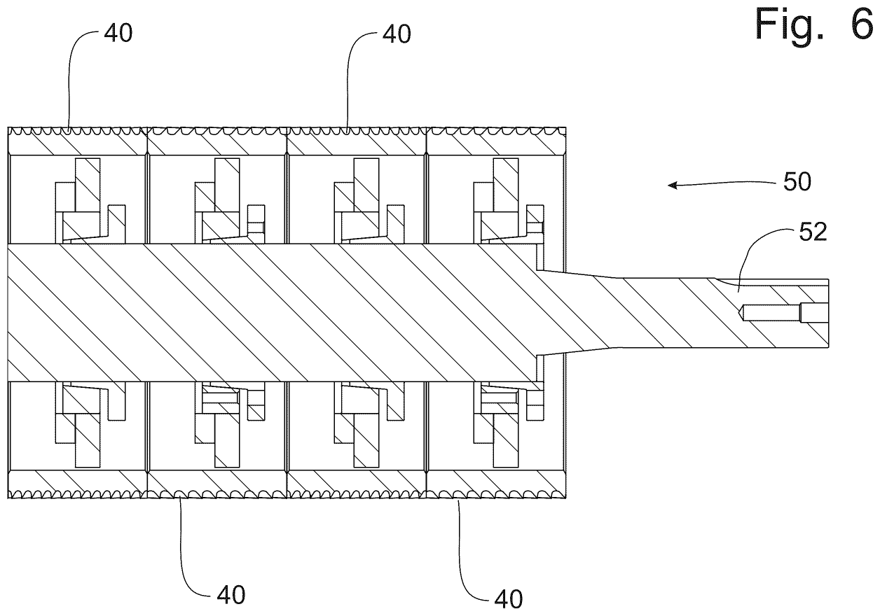

The fifth embodiment of a crop harvesting roll 22 is shown in FIGS. 5 and 6, which depict a crop harvesting roll 50 formed from a plurality of axially aligned roll segments 40 mounted on a drive shaft 52 extending through the center of the aligned segments 40. In this fifth embodiment of a crop harvesting roll 50 adjacent roll segments are formed with opposing leading slopes, with the leading slope of the opposing end segments being oriented to direct crop material away from the corresponding ends of the crop processing roll 50 where the roll bearings are located.

With respect to the shape of the respective grooves, one skilled in the art will understand that many other groove shapes can be utilized in forming both the longitudinally extending grooves 23 and the circumferential grooves 32, 35, so long as the shape of the grooves, the spacing of the grooves and the configuration of the groove pattern does not result in corn kernels passing through the processing rolls 22 without being cracked. Accordingly, the configuration of the grooves 23, 32, 35 must meet the basic requirement that the groove size and shape must be such that the grooves prevent corn kernels from being lodged within the groove, and not allow corn kernels from passing between the processing rolls 22 without being cracked.

To increase the operative life of the crop processing rolls 22, 50, the instant invention provides differential hardening of respective areas of a crop harvesting roll 22, 50, as is reflected on the fourth embodiment of the crop harvesting roll 22 in FIG. 4. The crop processing rolls 22, 50 are preferably formed from a shell 22a of steel. After the grooves have been milled into the circumferential surface of the roll shell 22a, the roll shells 22a are hardened to increase the operative life of the crop harvesting roll from an aspect of wear, but also to maintain the profile of the milled grooves and, thus, the operative effectiveness of the crop processing rolls 22, 50. Hardening of the steel roll shell 22a is conventionally done through a known conventional process of heat-treating the steel. However, alternative hardening processes are also known, including electroplating chrome onto the surface of the roll shell.

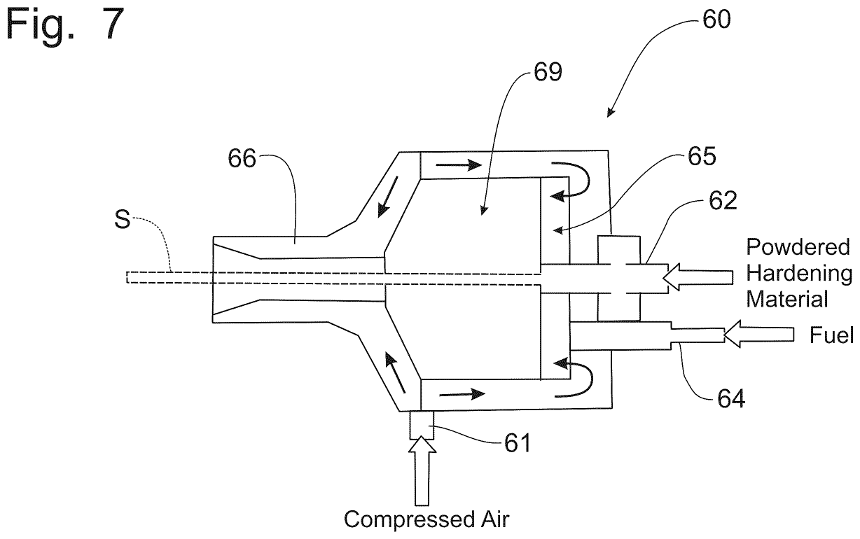

Another alternative hardening process is to harden through a high velocity air fuel (HVAF) system which uses an injection gun 60, schematically depicted in FIG. 7, that is capable of depositing cemented carbide and metal coatings onto the outer circumferential surface of the target roll shell 22a. These coatings exhibit high density and hardness, combined with excellent ductility, but is also a lower cost process than hardening through heat-treating or chrome electroplating. The “air” (in the HVAF process), i.e. oxidant and cooling gas, is preferably compressed air with optional oxygen inserted into the combustion air, fed into the injection gun 60 through the air inlet port 61. The “fuel” (in the HVAF process) is preferably propane, propylene, propane-butane, or natural gas and is fed into the injection gun 60 through the fuel inlet port 64. The injection gun 60 includes a mixing chamber 65 in which the compressed air and the fuel is mixed before being ignited in a combustion chamber 69 where the feedstock of cemented carbide and metal is passed through the material inlet port 62 in powdered form to be heated to, or slightly above, the melting temperature of the metal powdered particles being provided. As a result, an oxidation of the metal and a decomposition of the carbides are prevented and provide an even coating of hardening materials onto the target roll shell 22a.

High quality of the cemented carbide and metal coatings is enhanced by using a relatively low combustion temperature of the air-fuel mixture combined with an axial injection of the cemented carbide and metal feedstock through a long combustion chamber 69, where the low gas velocity provides sufficient time for the powdered particles of the feedstock to be gently heated. The acceleration of the feedstock particles occurs in the nozzle 66 of the injection gun 60 due to a significant reduction of the diameter of the nozzle 66 compared to the larger diameter of the combustion chamber 69 of the injection gun 60.

The hardening process using the HVAF system includes an infeed flow of the powdered cemented carbide and metal through the material inlet 62 into the injection gun 60. The thickness of the coating material through the stream S onto the target roll shell 22a is a function of the flow rate of the powdered particles fed through the material inlet 62 into the injection gun 60. By using an automated system, the movement of the injection gun 60 along the axial length of the roll shell 22a can have a flow rate of the powdered particles corresponding to the position of the injection gun 60 along the axial length of the roll shell 22a.

The wear pattern for crop processing rolls 22 is highest along the area that is from about zero to seven and a half inches from the end of the processing roll 22 that is about twenty-eight inches long. Accordingly, a thicker application of hardening material along the last seven and a half inches from each opposing end of the processing roll 22, compared to the central part of the crop processing roll 22, would improve the wear performance of the crop processing roll 22.

Taking a variable thickness of hardening material to a more finite application can result in the variable application of the hardening material to the crop processing roll in the areas between the lines indicated in FIG. 4. In the extreme end areas between lines A-B and G-H, a base application of the powdered hardening material is applied. Then, in the high wear areas between lines B-C and F-G, the powdered hardening material is applied at a thicker application, for example at a 14-18% increase in thickness. The area of the crop processing roll 22 between lines C-D and E-F can have the base application of powdered hardening material as at the extreme ends of the processing rolls 22. The remaining area of the crop processing roll 22 corresponding to the central portion between lines D and E, which normally shows a lower rate of wear, can have a reduced thickness of powdered hardening material compared to the base application, for example by about 5-8%.

In this manner, the hardening of the circumferential surface can be varied along the axial length of the roll shell 22a. An alternative process to provide variable thicknesses of hardened material can involve sequential passes of the injection gun 60, with the first pass providing a minimal layer corresponding to the desired thickness of the central area of the crop processing roll 22. A second pass would add a thickness equivalent to the difference between the minimal thickness in the central area and the base layer, with the second pass applying material to the desired ends of the crop processing roll, but not on the central area. The third pass would deposit the difference between the thickness of the base layer and the maximum desired thickness, but only be applied to the high wear areas.

In the way of specifics, the application of cemented carbide and metal through the injection gun 60 can have a base thickness in the range of 40 to 50 microns, the increased thickness in areas between lines B-C and F-G in the range of 46 to 58 microns, and the decreased thickness in the central area in the range of 37 to 47 microns. One skilled in the art will recognize that the line differentials shown in FIG. 4 are general in nature in that the changes in flow rate of the powdered hardening feedstock is not accomplished at a precise point in time and, therefore the thicknesses of the applied hardening material will ramp up and ramp down from one area to another.

Referring now to the fifth embodiment of the crop processing roll 52, as shown in FIGS. 5 and 6, each individual segment 40 can be manufactured and hardened through any suitable hardening process, including HVAF, heat-treating, electroplated chrome, etc., before being assembled into the crop processing roll 52, provided that the segments 40 are properly assembled to provide hardening material thickness in the areas of the crop processing roll 52 as desired. However, using the process noted above with the HVAF system, each segment 40 can be custom hardened and have areas of different thicknesses of hardened material applied to the surface of the crop processing roll segment.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

What is claimed is:

1. A crop processing roll for use in a forage harvester to process crop material comminuted by the operation of the forage harvester before being discharged from the forage harvester, comprising:
an elongated cylindrical body adapted for rotation about an axis of rotation and having formed therein a plurality of grooves into the outer circumferential surface of the cylindrical body; and
a hardening material applied to said outer circumferential surface through a high velocity air fuel (HVAF) process.

2. The crop processing roll of claim 1 wherein said grooves include a plurality of spirally oriented grooves formed on said outer circumferential surface.

3. The crop processing roll of claim 1 wherein said grooves include a plurality of parallel longitudinal grooves aligned parallel to the axis of the crop processing roll.

4. The crop processing roll of claim 1 wherein said grooves include a plurality of parallel grooves extending around the circumferential surface of the crop processing roll and spaced along the axial length thereof.

5. The crop processing roll of claim 1 wherein said hardening material is a cemented carbide and metal, applied to the surface of the crop processing roll by an injection gun applying a melted powder of said hardening material thereto.

6. The crop processing roll of claim 5 wherein said hardened material is applied at a variable rate to said circumferential surface of said crop processing roll, such that certain desired areas of said crop processing roll have different thicknesses of said hardened material.

7. The crop processing roll of claim 6 wherein said hardened material has a greater thickness near at least one end of said crop processing roll and a lesser thickness in a central portion of said crop processing roll.

8. A method of applying a hardening material to a target manufactured from steel, comprising the steps of:
providing a high velocity air fuel (HVAF) system for applying a melted powered hardened material to said steel target through an injection gun;
applying said hardened material to said steel target to provide different thicknesses of said hardened material to selected areas of said steel target.

9. The method of claim 8 wherein said applying step includes the step of:
depositing said hardened material to said steel target at a variable rate of application.

10. The method of claim 9 wherein said depositing step includes the step of:
changing a flow rate of said powdered hardened material into said injection gun to correspond to the desired thickness of hardened material for an area of said target where said injection gun is positioned.

11. The method of claim 10 wherein said flow rate is controlled by a microprocessor in said changing step.

12. The method of claim 11 wherein said steel target is a crop processing roll, said hardened material being applied to said crop processing roll in an application having greater thickness dimension in an area corresponding to at least one end portion of said crop processing roll.

13. The method of claim 12 wherein said hardened material is applied to said crop processing roll in an application having a lower thickness dimension in an area corresponding to a central portion of said crop processing roll.

14. A crop processing roll for use in a forage harvester to process crop material comminuted by the operation of the forage harvester before being discharged from the forage harvester, comprising:
an elongated cylindrical body adapted for rotation about an axis of rotation and having formed therein a plurality of grooves into the outer circumferential surface of the cylindrical body; and
said outer circumferential surface being hardened in a manner to establish a variable rate of hardening of said outer circumferential surface at the ends of said elongated cylindrical body compared a central portion of said elongated cylindrical body.

15. The crop processing roll of claim 14 wherein said outer circumferential surface of the crop processing roll is hardened by applying hardening material to said outer cylindrical surface through a high velocity air fuel (HVAF) process to deposit said hardening with different thicknesses of said hardening material along certain desired areas of said crop processing roll.

16. The crop processing roll of claim 15 wherein said hardening material has a greater thickness near at least one end of said crop processing roll and a lesser thickness in a central portion of said crop processing roll.

17. The crop processing roll of claim 15 wherein said hardening material is a cemented carbide and metal, applied to the surface of the crop processing roll by an injection gun applying a melted powder of said hardening material thereto.

18. The crop processing roll of claim 17 wherein said variable rate of hardening is accomplished by changing a flow rate of said powdered hardening material into said injection gun as said injection gun passes over predefined areas of the surface of said crop processing roll.

19. The crop processing roll of claim 14 wherein said cylindrical body is formed from multiple cylindrical segments, each cylindrical segment having a plurality of grooves in an outer cylindrical surface thereof, the outer surface of each said cylindrical segment being hardened in a preselected manner.

20. The crop processing roll of claim 19 wherein each respective cylindrical segment is hardened at the outer cylindrical surface thereof by one of heat treating, electroplating, or applying a hardening material thereto.
